(19) United States
(12) Patent Application Publication
(10) Pub. No.: US 2023/0200423 A1
(43) Pub. Date: Jun. 29, 2023

(54) AGGLOMERATED PROTEIN PRODUCTS AND METHOD FOR MAKING

(71) Applicant: GLANBIA NUTRITIONALS LIMITED, Kilkenny (IE)

(72) Inventors: Niels J. Palmer, Twin Falls, ID (US); Brent L. Petersen, Twin Falls, ID (US); Loren S. Ward, Twin Falls, ID (US)

(21) Appl. No.: 17/957,846

(22) Filed: Sep. 30, 2022

Related U.S. Application Data
(63) Continuation of application No. 15/705,192, filed on Sep. 14, 2017, now abandoned.
(60) Provisional application No. 62/394,394, filed on Sep. 14, 2016.

(51) Int. Cl. A23L 33/17; A23C 21/06; A23J 3/08; A23J 1/00; A23J 1/20

(52) U.S. Cl. CPC A23L 33/17; A23C 21/06; A23J 1/006; A23J 1/20; A23J 1/205; A23J 3/08; A23V 2002/00; A23V 2200/202

(57) ABSTRACT

Disclosed is a method for producing agglomerated proteins, agglomerated protein powders, and instantized protein powders using at least one protein binder to form agglomerates of at least one target protein.

### FIELD OF THE INVENTION

The present invention relates to methods for producing powdered agglomerated protein products. More specifically, the invention relates to the use of protein, hydrolyzed protein (peptides), and/or combinations thereof to produce agglomerated protein products.

### BACKGROUND OF THE INVENTION

According to Euromonitor, protein powders represented a market of about 4.7 billion dollars in the United States alone in 2015. That is expected to increase to about 7.5 billion dollars by 2020. Whey protein is considered a “complete” protein, containing all 9 of the essential amino acids. Whey protein promotes muscle synthesis, as well as promoting satiety and improving lean body mass.

Whey Protein Concentrate (WPC) and Whey Protein Isolate (WPI) are the most common sources of proteins in sports nutrition and dietary supplements, with protein contents typically in the range of 60% to 90%. The higher the protein level, the more difficult it can be to dissolve the powder in a liquid. High--protein powder tends to be hydrophilic, rewetting too quickly on the surface and forming a gelatinous layer at the interface of the powder and water—which prevents the water from penetrating the particles of the protein powder. Instead of dispersing quickly and evenly, the powder tends to form lumps as it is stirred into the liquid.

Consumers, who often mix protein powders into water, milk, or juice to produce protein drinks, smoothies, etc., want the protein powder to easily disperse into the chosen liquid, water, or milk. Quick and efficient dispersibility is essential in an “instant” product, as are wetting and sinking properties. Manufacturers must therefore “instantize” the protein powder.

Agglomeration, either alone or in combination with use of a surface-active agent, is performed to produce instantized protein powders. Agglomeration produces an increase in particle size and a more porous particle structure that generally improves penetration of the liquid into the particle.

During agglomeration of protein powders, dry particles, typically referred to as “fines,” are fed into a chamber with liquid. As the small particles are wetted, they collide into each other and form a cluster, or agglomerate. The process should produce agglomerates that have both good mechanical stability and good dispersibility.

The most commonly used agglomeration method combines lecithin, a phospholipid emulsifier used as a “binder,” with a target protein, such as whey protein, For example, Rogers (US2011/0070354A1) discloses the use of egg lecithin in a whey protein agglomeration method. The type of lecithin most commonly used is soy lecithin. In some studies, soy lecithin has been reported to be strongly estrogenic (Behr, M. et al., Estrogens in the daily diet: In vitro analysis indicates that estrogenic activity is omnipresent in foodstuff and infant formula, Food Chem. Toxicol. (October 2011) 49(10): 2681-2688). More importantly, studies performed at the Cleveland Clinic have suggested that exposure to dietary lecithin may affect susceptibility to both chronic kidney disease and cardiovascular disease (Tang, W.H.W. et al. Gut Microbiota-Dependent Trimethylamine N-Oxide (TMAO) Pathway Contributes to Both Development of Renal Insufficiency and Mortality Risk in Chronic Kidney Disease, Circulation Research (2015) 116: 448-455). Many consumers would therefore prefer a more “clean label” agglomerated protein product that is free of added lecithin.

What are needed are new methods for agglomerating proteins without the use of lecithin.

### SUMMARY OF THE INVENTION

The invention relates to a method for forming an agglomerated protein product without relying on lecithin as a binder. The invention relates to a method for forming an agglomerated protein product using protein as an agglomeration binder. Such products can comprise agglomerates formed of a first protein component binder and a second protein component target protein. Various embodiments of the method comprise hydrating a first protein component, adding the first protein component to a fluid bed comprising a second protein component, the first protein component being added to the fluid bed at a controlled rate of addition, and forming an agglomerate comprising the first protein component and the second protein component. In this method, the first protein component is used as a binder to form agglomerates of/with at least one target protein in the second protein component. In various embodiments, the first protein component comprises at least about 80 percent peptides of 18,000 kDa or less. In some embodiments, the first protein component comprises at least about 80 percent peptides of 7,000 kDa or less. In some embodiments, the first protein component comprises hydrolyzed protein. The first component can comprise peptides, polypeptides, and/or whole protein of animal, plant, and/or microbial origin, including, but not limited to, proteins selected from the group consisting of, whey protein, pea protein, soy protein, rice protein, wheat protein, hemp protein, barley protein, potato protein, flax protein, chia protein, and combinations thereof.

The second protein component can be any protein for which it is desirable to form an agglomerate that will promote instantizing a powder formed of the protein. The second component can comprise protein of animal, plant, and/or microbial origin, such as proteins selected from the group consisting of milk protein, whey protein, pea protein, soy protein, rice protein, wheat protein, hemp protein, barley protein, potato protein, flax protein, chia protein, and combinations thereof. In various embodiments of the invention, the second protein component can be whey proteins from whey protein products such as, for example, whey protein concentrate, whey protein isolate, and/or combinations thereof. In various embodiments of the invention, the second protein component can be selected from the group consisting of milk protein concentrate, milk protein isolate, and combinations thereof. The second protein component can also be selected from the group consisting of whey protein concentrate, whey protein isolate, milk protein concentrate, milk protein isolate, and combinations thereof.

In various embodiments, the first protein component can be a hydrolyzed plant-based protein, such as hydrolyzed pea protein (e.g., pea peptides).

The invention also provides a method for decreasing viscosity and increasing solubility of milk protein concentrates (MPC) and/or milk protein isolates (MPI), the method comprising using a protein binder to form agglomerates of protein selected from the group consisting of milk protein concentrates, milk protein isolates, and combinations thereof. In various embodiments, the protein binder comprises at least about 50% hydrolyzed protein.

### BRIEF DESCRIPTION OF THE DRAWINGS

FIG. 1a is a photo of dispersal of an agglomerated powder formed of milk protein concentrate and whey peptides, as compared to FIG. 1b, which is a photo of dispersal of an agglomerated powder formed of milk protein concentrate and sunflower lecithin.

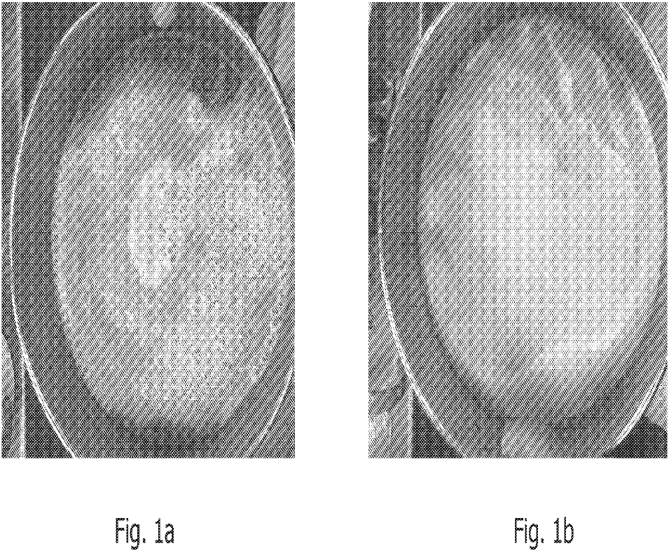

FIG. 2a is a photo of dispersal of an agglomerated powder formed of whey protein concentrate and whey peptides, as compared to FIG. 2b, which is a photo of dispersal of an agglomerated powder formed of whey protein concentrate and sunflower lecithin.

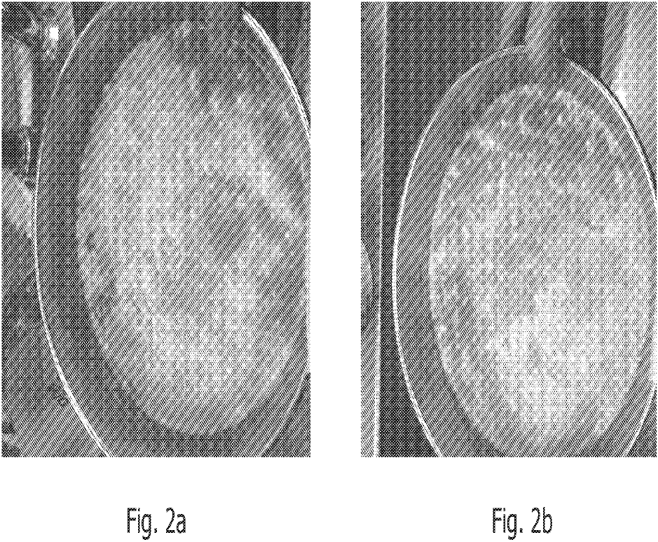

FIG. 3a is a photo of dispersal of an agglomerated powder formed of pea protein concentrate and pea peptides, as compared to FIG. 3b, which is a photo of dispersal of an agglomerated powder formed of pea protein concentrate and sunflower lecithin.

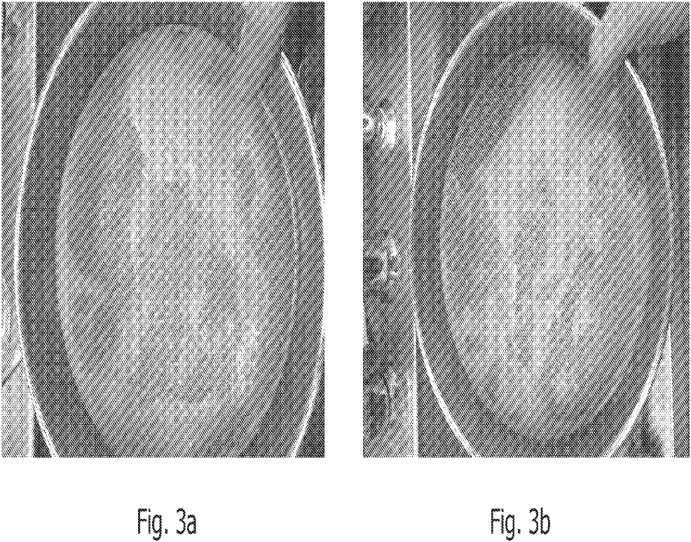

FIG. 4 is a graph of viscosity as a function of time for milk protein isolate agglomerated with sunflower lecithin (top line, SL) and milk protein isolate agglomerated with milk peptides (bottom line, DP). Lowering the viscosity of milk protein isolates and milk protein concentrates gives them broader utility in the food and beverage industry.

### DETAILED DESCRIPTION

The inventors have developed a method for agglomerating and instantizing whey protein to produce protein powders from high-protein whey protein products such as, for example, whey protein concentrate (WPC), whey protein isolate (WPI), and combinations thereof. Typically, these types of agglomerated protein powders have been produced using soy lecithin or egg lecithin, but the inventors have discovered that whey protein itself can be used to agglomerate and instantize whey protein.

The invention relates to a method for forming an agglomerated protein product, the method comprising hydrating a first protein component, adding the first protein component to a fluid bed comprising a second protein component, the first protein component being added to the fluid bed at a controlled rate of addition, and forming an agglomerate comprising the first protein component and the second protein. The first component can comprise protein (e.g., peptides, polypeptides, and/or whole protein) of animal, plant, or microbial origin, including, but not limited to, whey protein, pea protein, soy protein, rice protein, wheat protein, hemp protein, barley protein, potato protein, flax protein, and chia protein. In various embodiments, the first protein component comprises at least about 80 percent peptides of 18,000 kDa or less. In various embodiments, the first protein component comprises at least about 80 percent peptides of 7,000 kDa or less. The first protein component can also comprise hydrolyzed protein. Because the first protein component is hydrated and thereby aggregates molecules of the second protein component, the first component can be referred to as a “binder,” as the term is used in the field of protein agglomeration. In various embodiments, whey protein is transferred to a fluidized bed (“charged” into the bed), hydrated peptides are introduced into the bed, and the whey protein and hydrated peptides form agglomerates, the hydrated peptides acting as a binder to form agglomerates with the protein as the molecules come into contact with each other.

The second protein component can be any protein for which it is desirable to form an agglomerate that will promote instantizing a powder formed of the protein. The second component can comprise protein of animal, plant, and/or microbial origin, including, but not limited to, whey protein, pea protein, soy protein, rice protein, wheat protein, hemp protein, barley protein, potato protein, flax protein, and chia protein. In various embodiments of the invention, the second protein component can be whey proteins from whey protein products such as, for example, whey protein concentrate and whey protein isolate. Since the second protein component is the target of the agglomeration process, it can be referred to as the “target protein” for agglomeration. “Target protein” comprises “at least one target protein,” as some agglomerates may be formed from more than one protein or type of protein,

“Protein” and/or “Protein component” is defined as an ingredient in the disclosed agglomeration process that comprises protein, whether in the form of whole protein, polypeptides (“partially hydrolyzed protein,” “hydrolyzed protein,” etc.), for example. The protein may be hydrolyzed protein, partially hydrolyzed protein, intact (whole) protein, or a combination thereof, according to its use in the agglomeration process. Typically, the target protein will be whole protein, or at least about 50% whole protein. Likewise, the binder will likely comprise at least some hydrolyzed protein (i.e., peptides). However, the precise composition of each of the protein components can be determined by those of skill in the art according to the type of protein product to be produced. Proteins for use in the agglomeration process as target proteins, and from which binders can also be produced, can be from legumes, grains, vegetable sources, fruit, nuts, and/or seeds. Non-limiting examples include soybean protein/peptides, pea protein/peptides, wheat protein (e.g., gluten) and peptides, as well as protein and/or peptides from barley, rice, peanuts, and sunflower seeds. It should be understood by those of skill in the art that the method disclosed herein for forming “an agglomerate” will, given the fact that ingredient processing is done in bulk, actually form more than one agglomerate particles (“agglomerates”), and in fact will form many individual agglomerates, which are designed to have similar characteristics and properties.

In agglomeration technologies utilizing lecithin and a fluidized bed, the lecithin typically is hydrated, then introduced into a fluidized bed, usually by spraying the lecithin into the fluidized bed. As the lecithin is sprayed into the bed, whey protein is also sprayed into the bed, or the whey protein is introduced into the bed by a method known as “charging.” As the particles of whey protein come in contact with the hydrated lecithin, agglomerates form between the whey protein particles and the lecithin particles. The size and structure of the agglomerates can be controlled by the spray rate, temperature, pressure, and other factors known to those of skill in the art, these factors being selected by one of skill in the art according to the type of agglomerate that is desired.

In the method of the present invention, instead of hydrating lecithin, the inventors have hydrated a first protein component. They have discovered that their results are especially good if the first protein component is a hydrolyzed protein, although intact protein may also be used as the first protein component. Micronizing the first protein component is not necessary in the method of the invention, but may be performed if desired by the formulator. The hydrated first protein component is added to a fluidized bed of an agglomerator apparatus, such as, for example, the Midi Glatt agglomerator produced by Glatt GmbH (Germany). A second protein component, comprising at least one target protein to be agglomerated, is introduced into the fluidized bed, where it comes in contact with the hydrated first protein component. The second protein component generally comprises intact protein (which is understood to be substantially made up of full-length protein, although peptides and amino acids may also be present). As the second protein component comes into contact with the hydrated first protein component, agglomerates are formed.

Heated air can be introduced into the fluidized bed to maintain the temperature of the powder, as well as to dry the newly-formed agglomerated protein product. Agglomerates can be “sorted” by various means known to those of skill in the art in order to obtain an agglomerated protein product of consistent size throughout the product, if desired.

The method of the invention allows a manufacturer to produce an instantized whey protein powder, for example, that has the desired wetting and sinking properties to give the protein powder good dispersibility in a liquid such as, for example, water, milk, or juice.

Typically, when whey protein is stirred into water, for example, the outside particle mass is wetted first, forming a film or gel at the protein/water interface, inhibiting water from reaching the other particles of protein within the mass. This causes the protein to clump, or to sit on the surface of the water. To promote efficient wetting, sinking, and dispersal of the protein particles, agglomerates introduces bridges between the particles to allow water to circulate between the particles. Specialty equipment for agglomeration is available from a variety of sources, such as, for example Glatt GmbH (Germany), and the general methodology is known to those of skill in the art of protein processing. Briefly, the process for agglomerating a target protein using a commercial agglomerator may be performed as follows: a measured quantity of protein to be agglomerated is added to the interior of an agglomeration chamber, or fluidized bed, of the agglomerator. This process is referred to as “charging.” Air flow directed from the bottom of the agglomeration chamber upwards continuously disperses the protein powder upward, while a quantity of wetted binder molecules are sprayed into the upper part of the agglomeration chamber. As the wetted binder molecules come into contact with the powdered protein molecules, agglomerates are formed. As the air flow continues to circulate the agglomerated particles and protein powder upward to come into contact with the wetted binder molecules, agglomerates of larger and larger size are formed. When the agglomeration process is complete, the agglomerated protein particles are dried and discharged from the agglomerator. What the inventors have surprisingly discovered and developed is a method for agglomerating proteins using at least one protein binder, without having to rely on lecithin as a binder.

In one embodiment of the method of the invention, whey protein is charged into the agglomeration chamber and wetted protein or peptides are used for the binder. Peptides (synthesized or, more economically made by protein hydrolysis) are preferred, as they generally appear to provide a superior result. The protein from which the peptides are derived may be of plant, animal, and/or microbial origin. For example, peptides may be whey peptides, soy peptides, pea peptides, etc.

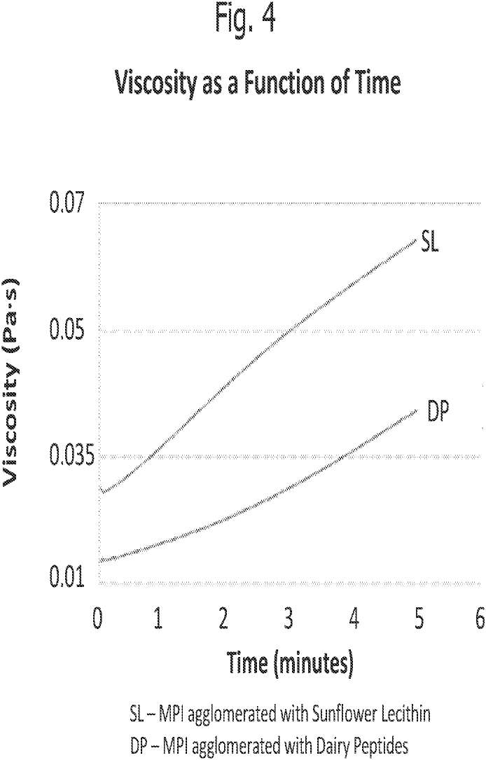

The inventors have also discovered that using peptides to form agglomerates of milk proteins (milk protein concentrate, milk protein isolate, etc.) provides a significantly better result than does the use of soy lecithin to form agglomerates of milk proteins, the use of a protein binder in the agglomeration process producing a milk protein concentrate and/or milk protein isolate product that is significantly less viscous. Their results are shown in the table of FIG. 4. Milk protein concentrates that contain 80% protein (MPC80) or higher have exhibited poor solubility when reconstituted into water, which restricts their use in food applications. The inventors have developed a method for decreasing viscosity and increasing solubility for MPC and MPI so they can readily be used as a food, beverage, and/or supplement ingredient as WPC and WPI have been. MPC and/or MPI substitution for WPC and/or WPI in a food product, for example, has been estimated to reduce the cost of producing the product by about twelve percent. Therefore, the invention also provides a method for producing an ingredient having the desirable properties of whey protein while decreasing the cost of production of the products into which it is incorporated.

The inventors have determined that it is not necessary to target a specific size range for the peptides to be used as the agglomerate binder in the method of the invention. They have also determined that Glanbia Nutritionals’ Thermax® 690, a hydrolyzed whey protein isolate product (>90% protein content) containing essential amino acids and providing a mild taste, produces excellent results. Therefore, they suggest that superior results may be obtained when the binder is selected to comprise at least about 80 percent peptides of 18,000 kDa or less. In some embodiments, the binder comprises at least about 80 percent peptides of 7,000 kDa or less.

Agglomerated powders formed by the method of the invention may be used in a variety of products, with superior results, as shown in FIG. 4, as compared to agglomerated protein powders formed by the use of a lecithin binder. Agglomerated powders made by the method of the invention may be used to provide protein powders for use in the sports nutrition industry, in the infant nutrition industry, and in the beverage industry, for example, Agglomerated powders of the invention may be provided in bulk to allow a consumer to measure a desired portion for dissolving into water, milk, or juice, for example, or may be provided in individual packets with a premeasured quantity of powder for added convenience.

The invention provides a product that can be made entirely of protein, without using lecithin to form the agglomerated protein product. However, one of skill in the art may also choose to form agglomerates using a combination of lecithin and protein as a binder, keeping in mind that the protein binder not only has shown better overall results in terms of product viscosity, but also improved flow of the agglomerated powder through processing equipment, and decreased “dusting.” Using protein and/or peptides as a binder to form the agglomerated protein powder increases the amount of protein in the end product and decreases consumer concern regarding the inclusion of non-protein products, such as lecithin. This provides a cleaner label for the manufacturer, as well. Some advantages of the use of protein as the agglomeration binder for protein, instead of lecithin, are listed in Table 1.

TABLE 1

Advantages of the Use of Protein Binder vs Lecithin Binder for Agglomerated Proteins
Decrease fat content
Increase protein content (Product is essentially 100% protein)
No requirement for soy allergen label
Clean label
Decreases viscosity of milk protein concentrates and milk protein isolates

Where the term “comprising” is used herein, the terms “consisting of” and/or “consisting essentially of” where a more narrow interpretation is desired, as inventions that “comprise” certain elements or limitations also “consist of” and/or “consist essentially of” those elements or limitations.

The invention may be further described by means of the following non-limiting examples.

### EXAMPLES

### Formation of Agglomerated Whey Protein Product With Whey Peptides

Water (140 ml) was added to a stainless steel beaker, then heated to 100° F. Twenty grams of Thermax® 690 (Glanbia Nutritionals, Madison WI) were added to the water and agitated for 15 minutes to fully hydrate the protein. Provon® 190 (400 g, Glanbia Nutritionals, Madison WI) was added into the bowl of a Midi Glatt agglomerates (Glatt GmbH, Binzen, Germany), with the inlet air set to 80° C. and the powder was heated in the bowl to 36° C. Provon® 190 is a whey protein isolate (WPC90). Nozzle pressure was set at 0.50 bar and the fluid bed air pressure was set at 35 bar.

The Thermax®/water solution was sprayed onto the Provon® fluid bed at the rate of 4 ml/min. During agglomeration, the powder temperature was maintained between 33 degrees and 36° C. by adjusting the pump speed. When all of the solution had been sprayed, the powder was heated to 105° F., then cooled before bagging. The moisture content of the powder was approximately 5-6 percent.

TABLE 2

Protein/Peptide Composition of Thermax® 690

| Percent Composition of Thermax® Product | Molecular Weight |
|---|---|
| 9% | > 18,000 |
| 7% | 7,000 - 18,000 |
| 56% | 1,000 - 7,000 |
| 29% | < 1,000 |

1-6. (canceled)

7. A method for forming an instantized agglomerated whey protein product, the method comprising
a. hydrating a whey protein component, wherein the whey protein component comprises at least about 80% whey peptides of 18.000 kDa or less, to produce a hydrated whey protein component; and
b. adding the hydrated whey protein component to a fluid bed comprising at least one target protein comprising whey protein concentrate (WPC) or whey protein isolate (WPI), the hydrated whey protein component being added to the fluid bed at a controlled rate of addition to form at least one instantized agglomerate consisting essentially of whey the protein .

8-21. (canceled)

21. The method of claim 7, wherein the whey protein component comprises at least about 80% peptides of 7.000 kDa or less.
